(19) United States
(12) Patent Application Publication
(10) Pub. No.: US 2023/0142599 A1
(43) Pub. Date: May 11, 2023

(54) CUSTOMIZABLE PAYMENT DEVICE

(71) Applicant: Jamie Lima, Woodinville, WA (US)

(72) Inventor: Jamie Lima, Woodinville, WA (US)

(21) Appl. No.: 17/521,776

(22) Filed: Nov. 8, 2021

(51) Int. Cl. G06Q 20/32

(52) U.S. Cl. CPC G06Q 20/3263; G06Q 20/3276; G06Q 20/3278

(57) ABSTRACT

A customizable payment device includes a storage having at least one application. A central processing unit (CPU) is coupled to the storage, and the CPU is configured to execute the at least one application. An input/output (I/O) interface is coupled to the CPU and to the storage. The at least one application comprises a multi-function payment application in which at least one payment function is limited in operation based on a particular product or service.

### BACKGROUND

### Technical Field

The present disclosure generally relates to cashless purchasing systems and methods, and more particularly to cashless purchasing by a payment device such as a smart card or debit card.

### Description of the Related Art

Recent advances in technology are being applied to smart cards and smartphones, particularly in the field of cashless purchasing. For example, debit cards are often a preferred payment method of payment in the United States. In addition, there is also a growing use of microchip-enabled debit cards (i.e. smartcards) in which the smartphones to purchase goods and services, and applications such as Google PayⓇ have increased in popularity.

It is becoming more common for people receiving government assistance, rebates, stimulus in the form of a smart card. Businesses are also using such systems and method for certain employee purchases instead of processing reimbursements. There is a desire to be able to restrict certain purchases

### SUMMARY

In one embodiment, payment device includes a storage having at least one application. A central processing unit (CPU) is coupled to the storage, and the CPU is configured to execute the at least one application. An input/output (I/O) interface coupled to the CPU and to the storage. The at least one application is a multi-function payment application in which at least one payment function is limited in operation based on a product or service.

In an embodiment, the at least one payment function of the multi-function payment application that is limited in operation is a cash withdrawal function.

In an embodiment, the at least one payment function of the multi-function payment application is limited in operation according to a brand of the product.

In an embodiment, the product that is limited by the multi-function payment application is a beverage containing alcohol.

In an embodiment, the multi-function payment application is configured to identify the product or service associated with the one or more functions limited in operation based on at least one of a Universal product code (UPC), a Quick Response (QR) code bar code of the product type, or a product name.

In an embodiment, the at least one payment function of the multi-function payment application is limited in operation according to a product type and a purchase price.

In an embodiment, wherein the at least one payment function of the multi-function payment application is limited in operation according to a store name identifying the seller of the product or service.

In an embodiment, the payment device is further configured to receive customization information via the I/O interface using at least one of Wi-Fi, Bluetooth, Bluetooth Low Energy, or near-field communication (NFC).

In an embodiment, the payment device is further configured to output payment information via the I/O interface, and the payment information includes an identification of a product or service for which payment is denied.

In an embodiment, the payment device is a contact smart card including a contact pad disposed on the CPU that is configured for communication with a card reader.

In an embodiment, the payment device is a contactless smart card, and the CPU is a chip module. An antenna is coupled to the I/O interface and configured for wireless communication.

In an embodiment, the contactless smart card is configured to receive customization information and dynamically reconfigure the multi-function payment application.

In an embodiment, the smart card is a Stored Value Card (SVC) in which one or more functions of the multi-function payment application are configured to restrict payment for the product or service based on an at least one of an identified a Universal product code (UPC), a QR code bar code of a product, or a name.

In an embodiment, the payment device is a wireless mobile device configured with the multi-function payment application.

In one embodiment, a computer-implemented method of providing payment by a smart card includes receiving a request to provide a payment for a product or a service. The smart card identifies whether the product or service is associated with a limited payment function of a multi-function payment application. A notification is output that the payment of the identified product or service is reduced or denied according to the limited payment function.

In one embodiment, a computing device is configured to perform a payment function. The computing device includes a processor, and a memory coupled to the processor. The memory stores instructions to cause the processor to perform acts including: receiving a request to provide a payment for a product or a service; identifying whether the product or the service is associated with one or more payment functions limited in operation based on at least one of a Universal product code (UPC), a Quick Response (QR) code bar code of the product type, or a product name; and reducing an amount of the requested payment, or denying the request to provide the payment for the product or the service when the product or service is identified with the one or more payment functions limited in operation.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition to or instead. Details that may be apparent or unnecessary may be omitted to save space or for more effective illustration. Some embodiments may be practiced with additional components or steps and/or without all the components or operations that are illustrated. When the same numeral appears in different drawings, it refers to the same or like components or operations.

FIG. 1A is an overview of a payment system having a payment device according to an embodiment of the present disclosure.

FIG. 1B illustrates some of the components of a smart card used in a payment device according to an embodiment of the present disclosure.

FIG. 2 illustrates an operation of a payment device according to an embodiment of the present disclosure.

FIG. 3 illustrates an operation of a smart device shown in FIG. 1B used to configure the payment device according to an embodiment of the present disclosure.

FIG. 4 illustrates a screen that displays settings of a multi-function payment application of the payment device according to an embodiment of the present disclosure.

FIG. 5 illustrates a limitations and restrictions display screen of a smart device used to customize the payment device according to an embodiment of the present disclosure.

FIG. 6 illustrates a customization feature of the limitations and restrictions display screen of a smart device used to customize the payment device according to an embodiment of the present disclosure.

FIG. 7 is a flowchart illustrating operations of a payment device according to an embodiment of the present disclosure.

### DETAILED DESCRIPTION

### Overview

In the following detailed description, numerous specific details are set forth by way of examples to provide a thorough understanding of the relevant teachings. However, it should be understood that the present teachings may be practiced without such details. In other instances, well-known methods, procedures, components, and/or circuitry have been described at a relatively high level, without detail, to avoid unnecessarily obscuring aspects of the present teachings.

The term “customizable” as used herein generally refers to a smart card that includes a microprocessor embedded in the card. For example, most Automatic Teller Machine (ATM) cards are constructed as a smart card including an embedded processor that can execute cryptographic algorithms, store data and applications.

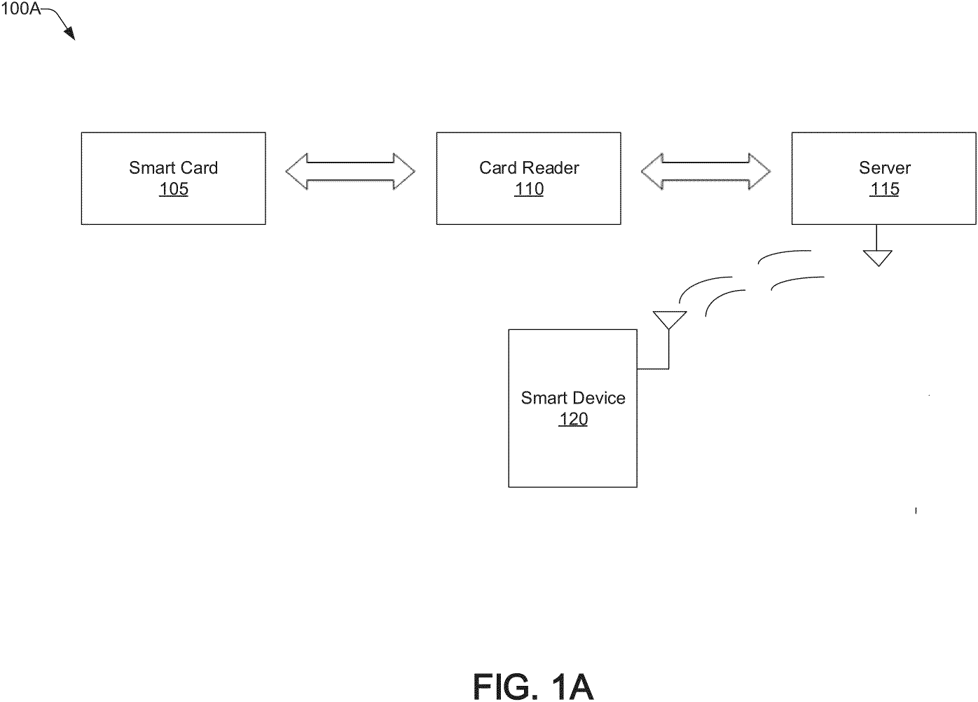

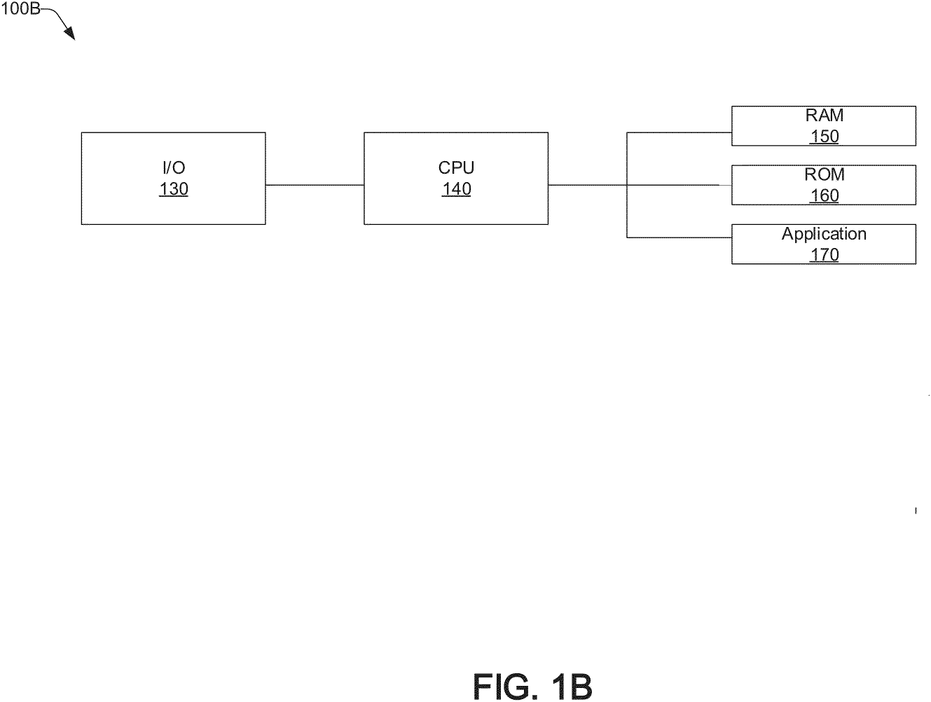

FIG. 1A is an overview 100A of a payment system having a payment device according to an embodiment of the present disclosure A smart card 105 communicates with a card reader 110 either by direct contact or wirelessly. The card reader 110 communicates with a server 115 that may be a payment server so that an amount of a purchase can be approved/ A smart device 120, such as a smartphone, can be used to issue or remove restrictions on use of the smart card 105 via the server 115. However, it is to be understood that the smart device could directly load information to the smart card by, for example, Bluetooth.

FIG. 1B illustrates some of the components 100B of a smart card 105 (shown in FIG. 1A) used in a payment device according to an embodiment of the present disclosure. The I/O interface 130 is configured to communicate with a card reader (such as shown in FIG. 1A) either wirelessly or through a contact pad. The I/O interface 130 communicates with a CPU 140, as well as RAM 150, Rom 160 and an application 170 in various storages within the smart card. Although only one application is shown in FIG. 1B, the smart card may have multiple applications. In addition, data unrelate to a payment function may also be stored in the card storage. The CPU 140 is typically a processor embedded in the card.

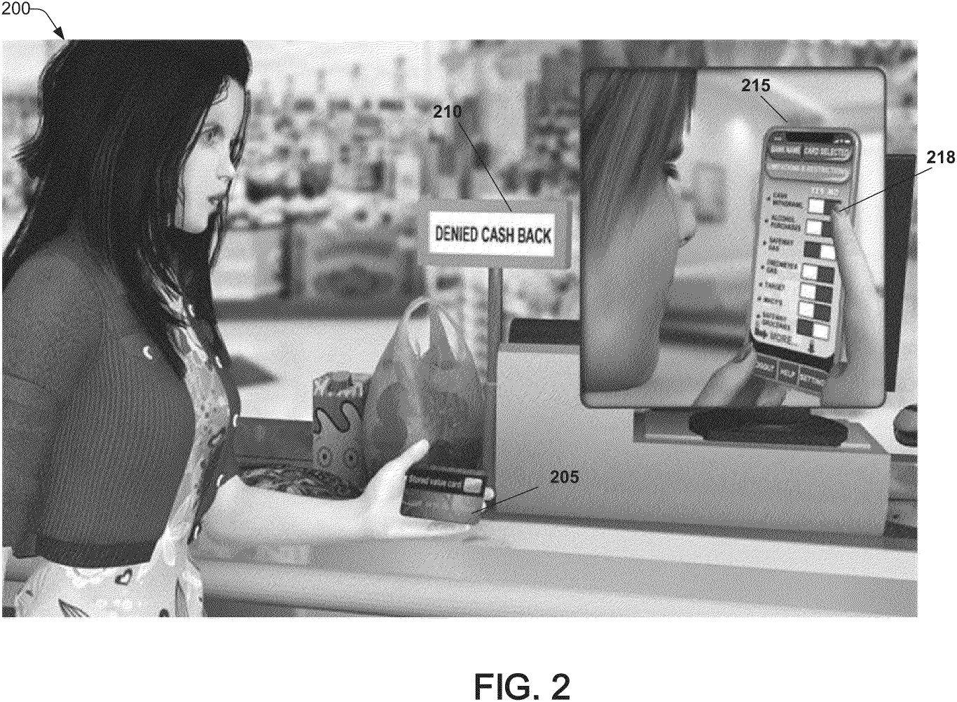

FIG. 2 is an overview 200 of a payment device according to an embodiment of the present disclosure. A smart card 205 has been configured to prevent the user from receiving cash back. Wireless device 215 displays an authorization screen 218 where the displayed cash withdrawal function is set to no. While the wireless device 215 shown is a smartphone, it is to be understood that any type of wired or wireless device, including a tablet, desktop, server, device can be used to change the cash withdrawal function of the smart card 205.

By virtue of the teachings herein, the computer-implemented method of the present disclosure provides an improvement in computer operations and in computer-implemented decision making using cashless payment systems.

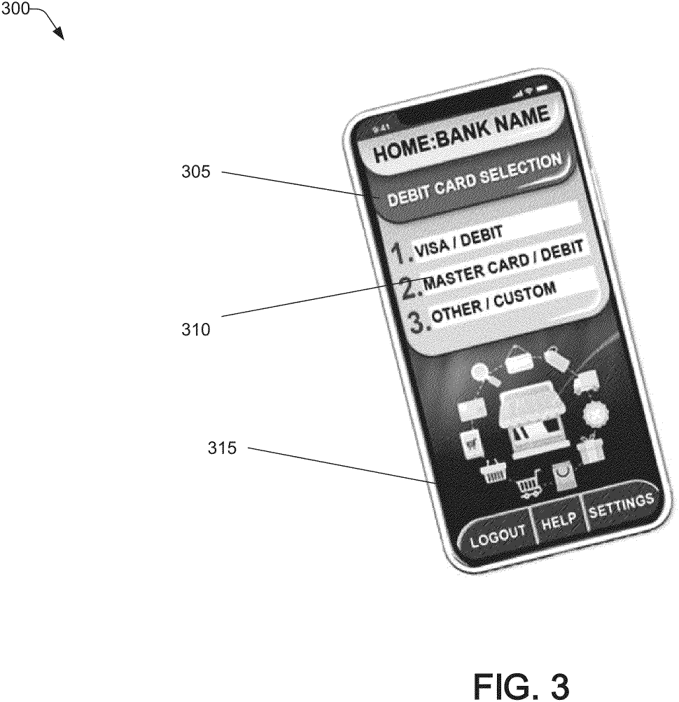

FIG. 3 illustrates an operation 300 of a smart device (such as smart device 120 shown in shown in FIG. 1A) used to configure a payment device such as a smart card 105 shown in FIG. 1A) according to an embodiment of the present disclosure. As shown from the display of the smart device, a debit card 305 that is a Mastercard/debit 310 of a particular bank is selected for configuration. A series of different customization icons 315 are shown in FIG. 3.

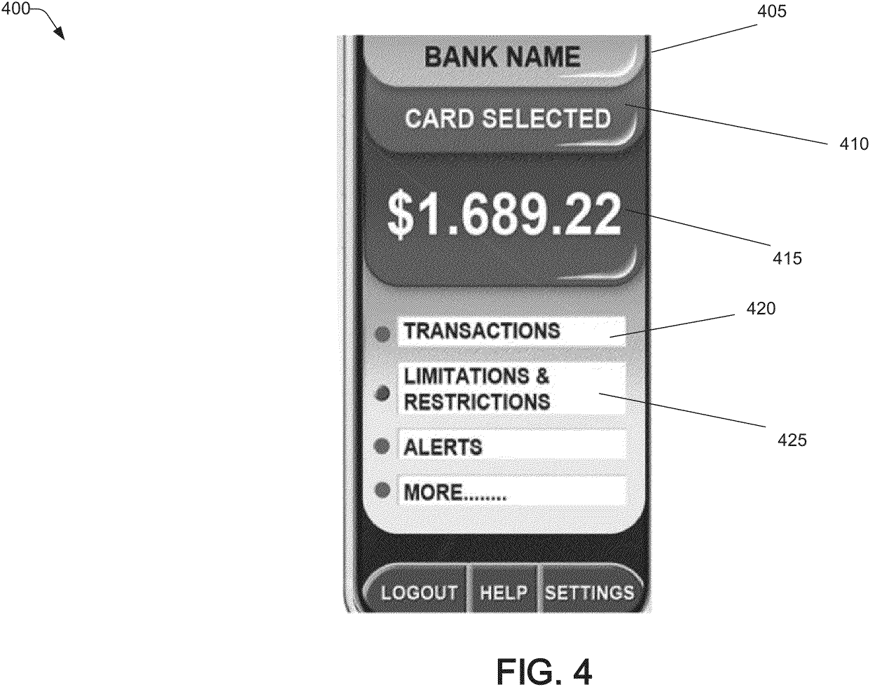

FIG. 4 illustrates a screen 400 of a smartphone (such as the smart device 120 shown in FIG. 1A) that displays settings of a multi-function payment application of the payment device according to an embodiment of the present disclosure. The bank name 405, the card selected 410, an amount 415, the transactions 420 and the limitations and restrictions 425 are selectable to customize the functions of a smart card such as shown in FIG. 1A. In this embodiment, these selections are transmitted from the smart device 120 to a server 115 (FIG. 1A) that is in communication with a smart card 105 via a card reader 110.

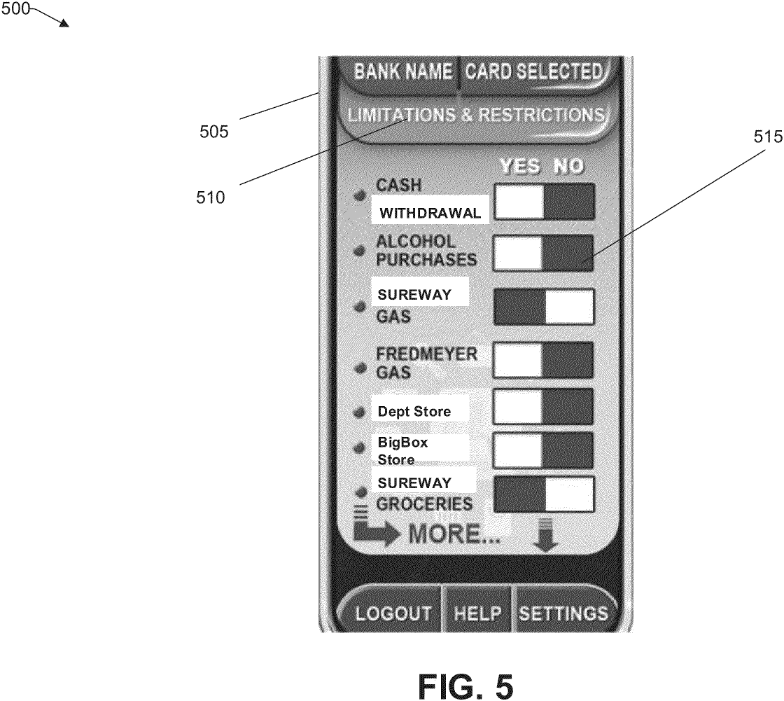

FIG. 5 illustrates a limitations and restrictions display screen 500 of a smart device used to customize the payment device according to an embodiment of the present disclosure. The bank name 505 and the limitations and restrictions 510 are again shown on the smart device. There are a series of virtual buttons 515 to permit or restrict cash withdrawals, alcohol purchases, specific stores, types of items being purchased. By submitting the updated limitations and restrictions, a smart card may be dynamically reconfigured with customizations regarding limitations on purchases.

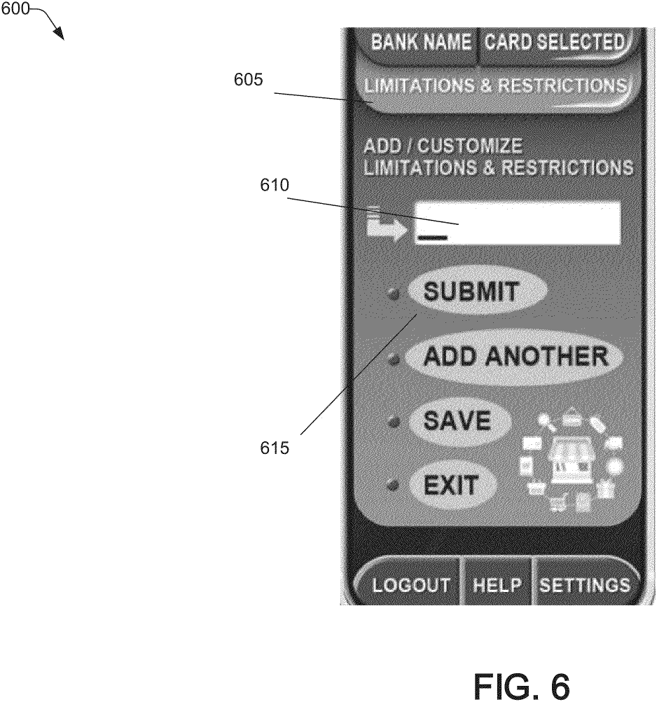

FIG. 6 illustrates a customization feature 600 of the limitations and restrictions display screen of a smart device used to customize the payment device according to an embodiment of the present disclosure.

As shown at 605, the particular feature (limitations and restrictions) is shown as being selected. At 610 there is an entry field to enter customized limitations, e.g., store selling the product, price, name of product, etc. At 615, function keys such as submit, add another limitation, save, and exit are shown. After the customization is typed in, the smart device can submit it to a server (such as shown in FIG. 1A) to dynamically customize a smart card.

### Example Process

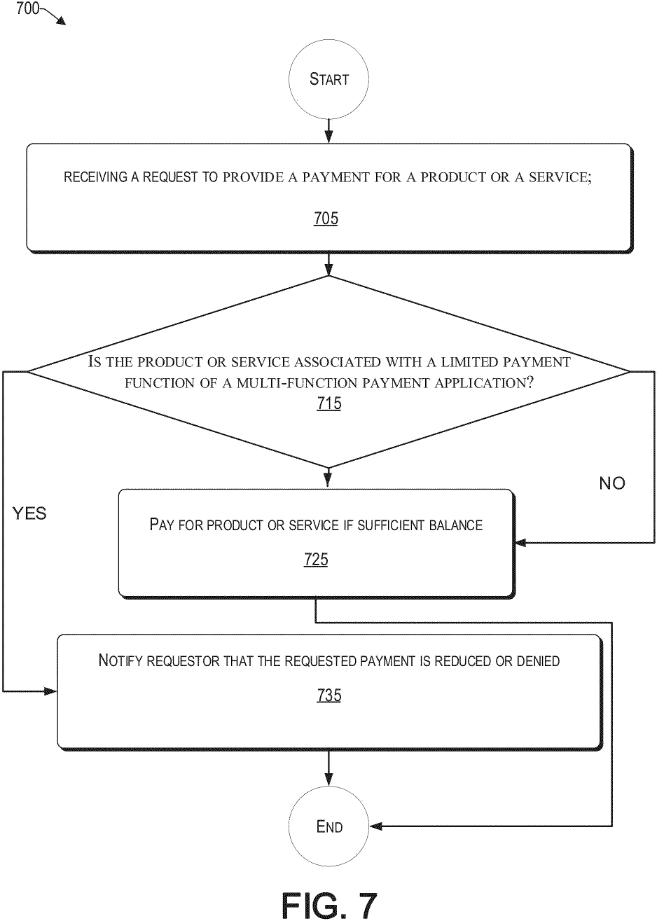

FIG. 7 is a flowchart illustrating a computer-implemented method of providing payment by a smart card, according to an illustrative embodiment of the present disclosure. FIG. 7 is shown as a collection of blocks, in a logical order, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At operation 705, a request is received for payment for a product or service. For example, the request may be received by placing a smart card into a card reader at a store. Alternatively, a contactless smart card may be brought within range of a wireless reader.

At operation 715, it is determined whether a product or service is associated with a limited payment function of a multi-function payment application. For example, as shown in FIG. 1B a smart card shown in 100B has an application 170, and storage in the form of Rom 150, RAM 160. The RAM may have a list of products and/or services that are not to be paid, or paid in a reduced amount or limited quantity. For example, the smart card may be programmed to permit limited payment amounts for purchases. For example, $30 per day on food and beverages can be set as a limit to prevent abuse. Alternatively, or in addition, there may be a numerical limit to the items purchased. Such a limit can prevent “false” purchases where a merchant scans items but does not actually sell them to the cardholder, providing them with a percentage (e.g., 50%) in cash, or substitutes a case of beer or a carton of cigarettes for a sham charge of five sandwiches.. If the answer at operation 715 is no, then at operation 725 the product is paid for if there is a sufficient balance. Such payment may be made by the I/O interface f the card contacting a payment server through the card reader (such as shown in FIG. 1A). In the case of a Stored Value Card (SVC) the payment can be made directly from the smart card.

With continued reference to operation 715, if the answer is yes (the product or service is associated with a limited payment function), the product or service, which may be identified by UPC code, QR code, name, brand, store sold etc., is listed as an exception for payment, and the payment function is limited to a prescribed limit such as discussed in the previous paragraph. Subsequently, at operation 735a notification is sent to the requestor that payment is reduced or denied. The method then ends until the card is attempted to be used for another payment.

### Conclusion

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The components, operations, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any such actual relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

What is claimed is:

1. A payment device, comprising:
a storage having at least one application;
a central processing unit (CPU) coupled to the storage, the CPU is configured to execute the at least one application; and
an input/output (I/O) interface coupled to the CPU and to the storage;
wherein the at least one application comprises a multi-function payment application in which at least one payment function is limited in operation based on a product or service.

2. The payment device of claim 1, wherein the at least one payment function of the multi-function payment application that is limited in operation comprises a cash withdrawal function.

3. The payment device of claim 1, wherein the at least one payment function of the multi-function payment application is limited in operation according to a brand of the product.

4. The payment device of claim 3, wherein the product that is limited by the multi-function payment application comprises beverages containing alcohol.

5. The payment device of claim 1, wherein the multi-function payment application is configured to identify the product or service associated with the one or more functions limited in operation based on at least one of a Universal product code (UPC), a Quick Response (QR) code bar code of the product type, or a product name.

6. The payment device of claim 1, wherein the at least one payment function of the multi-function payment application is limited in operation according to a product type and a purchase price.

7. The payment device of claim 1, wherein the at least one payment function of the multi-function payment application is limited in operation according to a store name identifying the seller of the product or service.

8. The payment device of claim 1, further configured to receive customization information via the I/O interface using at least one of Wi-Fi, Bluetooth, Bluetooth Low Energy, or near-field communication (NFC).

9. The payment device of claim 1, further configured to output payment information via the I/O interface; and
wherein the payment information includes an identification of a product or service for which payment is denied.

10. The payment device of claim 1, further comprising a contact smart card including a contact pad disposed on the CPU that is configured for communication with a card reader.

11. The payment device of claim 1, further comprising a contactless smart card in which the CPU comprises a chip module; and
an antenna coupled to the I/O interface and configured for wireless communication.

12. The payment device of claim 11, wherein the contactless smart card is configured to receive customization information and dynamically reconfigure the multi-function payment application.

13. The payment device of claim 11, wherein the smart card comprises a Stored Value Card (SVC) in which one or more functions of the multi-function payment application are configured to restrict payment for the product or service based on an at least one of an identified a Universal product code (UPC), a QR code bar code of the product or service, or a name.

14. The payment device of claim 1, further comprising a wireless mobile device configured with the multi-function payment application.

15. A computer-implemented method of providing payment by a smart card, the method comprising:
receiving a request to provide a payment for a product or a service;
identifying whether the product or service is associated with a limited payment function of a multi-function payment application;
outputting a notification that the payment of the identified product or service is reduced or denied according to the limited payment function.

16. The computer-implemented method according to claim 15, wherein the identifying the product or service is associated with a limited payment function based on at least one of a Universal product code (UPC), a Quick Response (QR) code bar code of the product, or a product name.

17. The computer-implemented method according to claim 16, wherein in response to receiving the request to provide the payment for the product or service, requesting an identification code of the product or service.

18. The computer-implemented method according to claim 16, further comprising:
dynamically reconfiguring an association of one or more products or services with the limited payment function of the multi-function payment application in response to a requested status change of the one or more products or services.

19. A computing device configured to perform a payment function, the computing device comprising:
a processor;
a memory coupled to the processor, the memory storing instructions to cause the processor to perform acts comprising:
receiving a request to provide a payment for a product or a service;
identifying whether the product or the service is associated with one or more payment functions limited in operation based on at least one of a Universal product code (UPC), a Quick Response (QR) code, bar code of the product type, or a product name; and
reducing an amount of the requested payment, or denying the requested payment for the product or the service when the product or service is identified with the one or more payment functions limited in operation.

20. The computing device according to claim 19, wherein the instructions cause the processor to perform an additional act comprising:
outputting a notification that the payment of the identified product or service is reduced or denied.
